(19) United States
(12) Patent Application Publication
(10) Pub. No.: US 2006/0124218 A1
(43) Pub. Date: Jun. 15, 2006

(54) Tyre for vehicle wheels and elastomeric composition used therein

(76) Inventors: Marco Nahmias Nanni, Milano (IT); Antonio Serra, Genova (IT); Raffaele Ceccarelli, Sutri (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/522,477

(22) PCT Filed: Jul. 31, 2002
(86) PCT No.: PCT/EP02/08533

§ 371 Date: Sep. 29, 2005

(51) Int. Cl. B60C 1/00; B60C 13/00; C08K 5/01

(52) U.S. Cl. 152/525; 524/62

(57) ABSTRACT

An elastomeric composition includes at least one diene elastomeric polymer, at least one paraffin wax, and at least one polymer of at least one C₃-C₂₄ α-olefin having a number average molecular weight not higher than 10,000. A tyre for a vehicle wheel includes at least one structural element made of a crosslinked elastomeric material. The crosslinked elastomeric material includes the elastomeric composition. The tyre may include a carcass structure including at least one carcass ply shaped in a toroidal configuration, a belt structure including at least one belt strip applied in a circumferentially external position relative to the carcass structure, a tread band superimposed circumferentially on the belt structure, and a pair of sidewalls applied laterally on opposite sides relative to the carcass structure. The pair of sidewalls may be formed by the elastomeric composition. A crosslinked elastomeric manufactured product is obtained by crosslinking the elastomeric composition.

The present invention relates to a tyre for vehicle wheels and to a crosslinkable elastomeric composition.

More particularly, the present invention relates to a tyre for vehicle wheels comprising at least one structural element made of crosslinked elastomeric material including at least one paraffin wax and at least one low molecular weight polymer of at least one α-olefin.

The present invention moreover relates an elastomeric composition comprising one paraffin wax and at least one low molecular weight polymer of at least one α-olefin.

It is known that exposure to sunlight and atmosphere causes crosslinked elastomeric compositions to crack thereby causing a poor appearance or, eventually, with prolonged exposure, actual failure. It is also known that ozone will attack the unsaturated double bonds in crosslinked elastomeric compositions causing a break in the chain (“chain scission”).

In order to prevent said cracks, it is usual to add additives to the elastomeric compositions. These additives may be classified in two classes: (1) antiozonants and (2) waxes. Usually, both of said materials may be added to the elastomeric compositions, e.g. being mixed by conventional methods such as, for example, in a Banbury mixer or in a mill. It is believed that antiozonants such as, for example, amines or quinolines, react selectively with the atmospheric ozone thus avoiding oxidative reactions with the crosslinked elastomeric compositions, whereas waxes migrate to the surface of the crosslinked elastomeric compositions to form a thin film which prevents the crosslinked elastomeric compositions from contacting with ozone.

However, when waxes are used, some drawbacks may occur. In particular, the surface of the crosslinked elastomeric compositions may be discolored to white when the waxes migrate excessively thus causing, in particular in the case of tyre sidewalls, an undesired change in the appearance of the finished product.

Some efforts have been made in the prior art in order to avoid said discoloration phenomena.

For example, Japanese Patent Application JP 11-181150 relates to a rubber composition comprising 100 part by weight of at least one rubber component selected from the group consisting of natural rubber, isoprene rubber, butadiene rubber and styrene-butadiene rubber; and 1-2.5 parts by weight of a wax, wherein the wax is a saturated chain hydrocarbon comprising a n-paraffin and an iso-paraffin, the quantity of the n-paraffin in the saturated chain hydrocarbon being from 75% to 85% by weight, the peak value of carbon atoms in the saturated chain being from 30 to 35, and the quantity of saturated chain hydrocarbon containing more than 45 carbon atoms being from 3% to 10% by weight. Said rubber composition may be used for manufacturing rubber articles, in particular a tread and/or sidewalls of pneumatic tyres and is said to avoid the generation of cracks and the discoloration phenomena in said rubber articles.

Japanese Patent Application JP 2000/086824 relates to a rubber composition comprising (A) 100 parts by weight of a rubber; (B) 0.5-10 parts by weight of a petroleum wax and (C) 1-10 parts by weight of an olefin resin. The petroleum wax (B) comprises (B1) a lower molecular weight fraction constituted by compounds having 24-29 carbon atoms and a branched hydrocarbon content from 10% to 15% by weight and (B2) a higher molecular weight fraction constituted by compounds having from 32 to 38 carbon atoms and a branched hydrocarbon content from 18% to 25% by weight. Said rubber composition may be used for manufacturing rubber articles, in particular structural elements of pneumatic tyres. Said rubber articles are said to have an improved resistance to ozone cracking and to avoid discoloration phenomena.

Patent U.S. Pat. No. 6,201,049 relates to a rubber composition for a tyre sidewall obtained by blending 0.5 to 2.5 parts by weight of a wax which contains a component having 45 or more carbon atoms and has an average number of carbon atoms of 28 to 38, and 3.0 to 7.0 parts by weight of an antioxidant containing 30% to 100% by weight of N-(1-methylheptyl)-N′-phenyl-p-phenylenediamine per 100 parts by weight of a rubber component comprising a diene rubber. Said rubber composition is said to avoid cracking caused by ozone and the discoloration phenomena.

The Applicant has now found that it is possible to avoid the above mentioned discoloration phenomena and, at the same time, to improve resistance to ozone, by adding at least one low molecular weight polymer of at least one α-olefin to the crosslinkable elastomeric compositions comprising at least one paraffin wax. The obtained crosslinkable elastomeric compositions are advantageously used in the production of crosslinked elastomeric manufactured products, in particular in the production of tyres, especially tyre sidewalls.

According to a first aspect, the present invention thus relates to a tyre for vehicle wheels comprising at least one structural element made of a crosslinked elastomeric material, in which said crosslinked elastomeric material includes an elastomeric composition comprising:

(a) at least one diene elastomeric polymer;

(b) at least one paraffin wax;

(c) at least one polymer of at least one C₃-C₂₄, preferably C₅-C₁₈, α-olefin, said polymer having a number average molecular weight not higher than 10,000.

According to one preferred embodiment, said polymer (c) has a number average molecular weight not higher than about 5,000, more preferably not higher than about 3,000.

According to a further preferred embodiment, said polymer (c) has a number average molecular weight of at least about 300, preferably of at least about 400, and more preferably of at least about 500.

The number average molecular weight of the polymer (c) may be determined by means of conventional techniques such as, for example, by vapor pressure osmometry.

According to one preferred embodiment, the present invention relates to a tyre for vehicle wheels, comprising:

a carcass structure with at least one carcass ply shaped in a substantially toroidal configuration, the opposite lateral edges of which are associated with respective right-hand and left-hand bead wires, each bead wire being enclosed in a respective bead;

a belt structure comprising at least one belt strip applied in a circumferentially external position relative to said carcass structure;

a tread band superimposed circumferentially on said belt structure;

a pair of sidewalls applied laterally on opposite sides relative to said carcass structure;

in which said pair of sidewalls is formed by said elastomeric composition.

According to a further aspect, the present invention relates to an elastomeric composition comprising:

(a) at least one diene elastomeric polymer;

(b) at least one paraffin wax;

(c) at least one polymer of at least one C₃-C₂₄, preferably C₅-C₁₈, α-olefin, said polymer having a number average molecular weight not higher than 10,000.

According to a further aspect, the present invention relates to a crosslinked elastomeric manufactured product obtained by crosslinking the abovementioned elastomeric composition

According to one preferred embodiment, the diene elastomeric polymer (a) which may be used in the present invention may be selected from those commonly used in sulphur-crosslinkable elastomeric compositions, that are particularly suitable for producing tyres, that is to say from elastomeric polymers or copolymers with an unsaturated chain having a glass transition temperature (T_{g}) generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene and isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene elastomeric polymer (a) which may be used in the present invention may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The elastomeric composition according to the present invention may optionally comprise at least one elastomeric polymer of one or more monoolefins with an olefinic comonomer or derivatives thereof (a′) . The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

A diene elastomeric polymer (a) or an elastomeric polymer (a′) functionalized by reaction with suitable terminating agents or coupling agents may also be used. In particular, the diene elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European patent EP 451 604, or patents U.S. Pat. No. 4,742,124 and U.S. Pat. No. 4,550,142).

The paraffin wax (b) according to the present invention may be selected from waxes which comprise linear saturated hydrocarbons (“normal-paraffins”) and/or branched saturated hydrocarbons (“iso-paraffins”).

According to one preferred embodiment, the paraffin wax (b) which may be used in the present invention may comprise a mixture of linear and branched saturated hydrocarbons, in which the content of linear saturated hydrocarbon is at least 40% by weight, preferably of from 55% by weight to 80% by weight.

Preferably, the linear saturated hydrocarbon has the following composition:

at least from 20 to 29 carbon atoms in an amount of from 10% by weight to 40% by weight, preferably from 15% by weight to 30% by weight;

at least from 30 to 35 carbon atoms in an amount of from 20% by weight to 65% by weight, preferably from 35% by weight to 50% by weight;

at least from 36 to 42 carbon atoms in an amount of from 10% by weight to 50% by weight, preferably from 15% by weight to 40%.

According to one preferred embodiment, the paraffin wax (b) is present in the elastomeric composition in an amount of from 0.5 phr to 10 phr, preferably from 1.5 phr to 4 phr.

For the purposes of the present description and of the claims, the term “phr” means the parts by weight of a given component of the elastomeric composition per 100 parts by weight of elastomeric polymer.

The paraffin wax (b) according to the present invention can be obtained according to any process known in the art. For example, a desired paraffin wax (b) may be obtained by distillation of petroleum-originated wax or of a synthesized wax. Alternatively, the paraffin wax (b) according to the present invention may be obtained by blending different waxes. Further details regarding processes for the production of the paraffin wax (b) are disclosed, for example, in U.S. Pat. No. 3,838,080, in U.S. Pat. No. 3,856,731 or in U.S. Pat. No. 5,296,129.

The composition of the paraffin wax (b) may be determined by means of conventional techniques such as, for example, by capillary gas-chromatography.

Examples of paraffin waxes (b) which may be used in the present invention and which are currently commercially available are the products SER® A054 from Ser and REDEZON® 517 from Repsol.

According to a preferred embodiment, the polymer (c) has a polydispersity value of at least about 2, preferably not higher than about 20, more preferably not higher than about 12.

According to a further preferred embodiment, the polymer (c) has a melting point (for crystalline forms) or a softening point (for amorphous or semicrystalline forms) of at least about 30° C., preferably of at least about 35° C., more preferably of at least about 50° C. Usually, the polymer (c) has a melting point or a softening point not higher than about 120° C., preferably not higher than about 110° C., more preferably of not higher than about 100° C.

According to a further preferred embodiment, the polymer (c) has the following degree of branching (or average number of branches per molecule): from 1 mol % to 20 mol % preferably from 2 mol % to 10 mol %, of methyl groups with respect to the total number of carbon atoms.

According to a further preferred embodiment, the polymer (c) has the following degree of branching:

from 80 mol % to 99 mol %, preferably from 90 mol % to 95 mol % of methylene groups (secondary carbon atoms) with respect to the total number of carbon atoms;

from 1 mol % to 20 mol %, preferably from 2 mol % to 10 mol % of tertiary carbon atoms with respect to the total number of carbon atoms;

from 0 mol % to 2 mol %, preferably from 0 mol % to 1 mol %, of quaternary carbon atoms with respect to the total number of carbon atoms.

According to a further preferred embodiment, the polymer (c) has a crystallinity degree of from 30% to 99%, preferably of from 50% and 90%.

Both the degree of branching and the crystallinity degree may be determined by means of conventional techniques such as, for example, by solid state NMR, operating in MAS (Magic Anngle Spinning) mode, from the two different signals detected at 30.2 ppm and at 32.7 ppm for the amorphous form and the crystalline form respectively.

According to a further preferred embodiment, the polymer (c) may be saturated or unsaturated and may comprise cyclic moieties.

According to one preferred embodiment, the polymer (c) is present in the elastomeric composition in an amount of from 0.1% to 10% by weight, preferably from 0.5% to 5% by weight, with respect to the weight of the paraffin wax (b).

The polymer (c) may be obtained by polymerizing at least one α-olefin of formula RCH═CH₂ wherein R represents an alkyl group having from 1 to 22 carbon atoms, preferably from 3 to 16 carbon atoms, in the presence of a radical initiator, operating at a pressure low but sufficient to prevent the reactants and products from vaporizing. Usually, said polymerization is carried out at temperature of from about 40° C. to about 250° C. and at a pressure not higher than about 500 psi for a period of 7 to 20 times the half-life time of the radical initiator, and a molar ratio of radical initiator to α-olefins of about 0.005 to about 0.35.

Examples of polymers (c) which may be used in the present invention and which are currently commercially available are the products VYBAR® from Baker Petrolite Corp. such as, for example, VYBAR® 103 having a number average molecular weight of 2800 and VYBAR® 260 having a number average molecular weight of 2600.

At least one reinforcing filler may advantageously be added to the elastomeric composition according to the present invention, in an amount generally of from 0.1 phr to 120 phr, preferably from 20 phr to 90 phr. The reinforcing filler may be selected from those commonly used for crosslinked manufactured products, in particular for tyres, such as, for example, carbon black, silica, alumina, aluminosilicates, calcium carbonate, kaolin, or mixtures thereof.

The types of carbon black which may be used in the present invention may be selected from those conventionally used in the production of tyres, generally having a surface area of not less than 20 m²/g (determined by CTAB absorption as described in ISO standard 6810).

The silica which may be used in the present invention may generally be a pyrogenic silica or, preferably, a precipitated silica, with a BET surface area (measured according to ISO standard 5794/1) of from 50 m²/g to 500 m²/g, preferably from 70 m²/g to 200 m²/g.

When a reinforcing filler comprising silica is present, the elastomeric composition may advantageously incorporate a coupling agent capable of interacting with the silica and of linking it to the elastomeric base during the vulcanization.

Coupling agents that are preferably used are those based on silane which may be identified, for example, by the following structural formula (I):
(R)₃Si—CₙH₂ₙn—X (I)
in which the groups R, which may be identical or different, are selected from: alkyl, alkoxy or aryloxy groups or from halogen atoms, on condition that at least one of the groups R is an alkoxy or aryloxy group; n is an integer between 1 and 6 inclusive; X is a group selected from: nitroso, mercapto, amino, epoxide, vinyl, imide, chloro, —(S)ₘCₙH₂ₙ—Si—(R)₃ in which m and n are integers between 1 and 6 inclusive and the groups R are defined as above.

Among the coupling agents that are particularly preferred are bis(3-triethoxysilylpropyl) tetrasulphide and bis(3-triethoxysilylpropyl) disulphide. Said coupling agents may be used as such or as a suitable mixture with an inert filler (for example carbon black) so as to facilitate their incorporation into the elastomeric composition.

The elastomeric composition according to the present invention may be vulcanized according to known techniques, in particular with sulphur-based vulcanizing systems commonly used for diene elastomeric polymers. To this end, in the composition, after one or more stages of thermomechanical processing, a sulphur-based vulcanizing agent is incorporated together with vulcanization accelerators. In the final processing stage, the temperature is generally kept below 120° C. and preferably below 100° C., so as to avoid any unwanted pre-cross-linking phenomena.

The vulcanizing agent most advantageously used is sulphur, or molecules containing sulphur (sulphur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected from: dithiocarbamates, guanidine, thiourea, thiazoles, sulphenamides, thiurams, amines, xanthates, or mixtures thereof.

The elastomeric composition according to the present invention may comprise other commonly used additives selected on the basis of the specific application for which the composition is intended. For example, the following may be added to said composition: antioxidants, anti-ageing agents, plasticizers, adhesives, anti-ozone agents, modifying resins, fibres (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to the elastomeric composition according to the present invention. The amount of plasticizer generally ranges from 0 phr to 70 phr, preferably from 5 phr to 30 phr.

The elastomeric composition according to the present invention may be prepared by mixing together the polymeric components with the reinforcing filler and with the other additives optionally present according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss) or of co-rotating or counter-rotating twin-screw type.

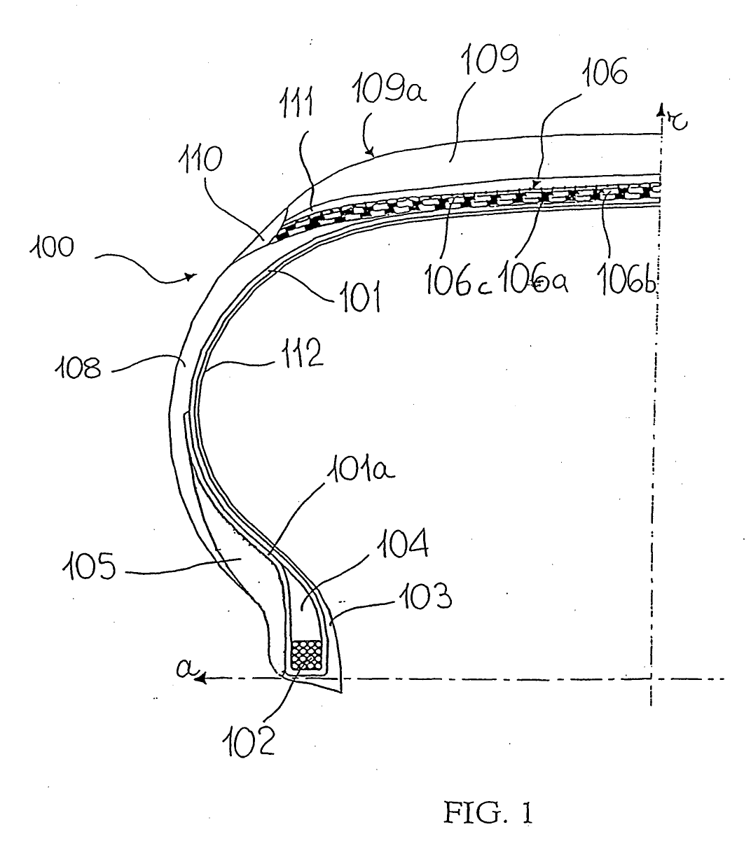

The present invention will now be illustrated in further detail by means of a number of illustrative embodiments, with reference to the attached FIG. 1, which is a view in cross section of a portion of a tyre made according to the present invention.

“a” indicates an axial direction and “r” indicates a radial direction. For simplicity, FIG. 1 shows only a portion of the tyre, the remaining portion not represented being identical and symmetrically arranged with respect to the radial direction “r”.

The tyre (100) comprises at least one carcass ply (101), the opposite lateral edges of which are associated with respective bead wires (102). The association between the carcass ply (101) and the bead wires (102) is achieved here by folding back the opposite lateral edges of the carcass ply (101) around the bead wires (102) so as to form the so-called carcass back-folds (101a) as shown in FIG. 1.

Alternatively, the conventional bead wires (102) may be replaced with a pair of circumferentially inextensible annular inserts formed from elongate components arranged in concentric coils (not represented in FIG. 1) (see, for example, European patent applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of elastomeric compound. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. Each bead wire (102) is enclosed in a bead (103), defined along an inner circumferential edge of the tyre (100), with which the tyre engages on a rim (not represented in FIG. 1) forming part of a vehicle wheel. The space defined by each carcass back-fold (101a) contains a bead filler (104) in which the bead wires (102) are embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A sidewall (108), which may be made according to the present invention, is also applied externally onto the carcass ply (101), this sidewall extending, in an axially external position, from the bead (103) to the end of the belt structure (106).

A tread band (109), whose lateral edges are connected to the sidewalls (108), is applied circumferentially in a position radially external to the belt structure (106). Externally, the tread band (109), has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-sidewall”, which may be made according to the present invention, may optionally be present in the connecting zone between the sidewalls (108) and the tread band (109), this mini-sidewall generally being obtained by co-extrusion with the tread band and allowing an improvement in the mechanical interaction between the tread band (109) and the sidewalls (108). Alternatively, the end portion of the sidewall (108) directly covers the lateral edge of the tread band (109). A underlayer which forms, with the tread band (109), a structure commonly known as a “cap and base” (not represented in FIG. 1) may optionally be placed between the belt structure (106) and the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tyres, a rubber layer (112) generally known as a “liner”, which provides the necessary impermeability to the inflation air of the tyre, may also be provided in a radially internal position relative to the carcass ply (101).

The process for producing the tyre according to the present invention may be carried out according to techniques and using apparatus that are known in the art, as described, for example, in patents EP 199 064, U.S. Pat. No. 4,872,822, U.S. Pat. No. 4,768,937, said process including at least one stage of manufacturing the green tyre and at least one stage of vulcanizing this tyre.

More particularly, the process for producing the tyre comprises the stages of preparing, beforehand and separately from each other, a series of semi-finished products corresponding to the various structural elements of the tyre (carcass plies, belt structure, bead wires, fillers, sidewalls and tread band) which are then combined together using a suitable manufacturing machine. Next, the subsequent vulcanization stage welds the abovementioned semi-finished products together to give a monolithic block, i.e. the finished tyre.

Naturally, the stage of preparing the abovementioned semi-finished products will be preceded by a stage of preparing and moulding the various blends, of which said semi-finished products are made, according to conventional techniques.

The green tyre thus obtained is then passed to the subsequent stages of moulding and vulcanization. To this end, a vulcanization mould is used which is designed to receive the tyre being processed inside a moulding cavity having walls which are countermoulded to define the outer surface of the tyre when the vulcanization is complete.

Alternative processes for producing a tyre or parts of a tyre without using semi-finished products are disclosed, for example, in the abovementioned patent applications EP 928,680 and EP 928,702.

The green tyre can be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding can be carried out without an inflatable vulcanization chamber, by providing inside the tyre a toroidal metal support shaped according to the configuration of the inner surface of the tyre to be obtained as decribed, for example, in patent EP 242,840. The difference in coefficient of thermal expansion between the toroidal metal support and the crude elastomeric material is exploited to achieve an adequate moulding pressure.

At this point, the stage of vulcanizing the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material can vary in general between 3 min and 90 min and depends mainly on the dimensions of the tyre. When the vulcanization is complete, the tyre is removed from the vulcanization mould.

Although the present invention has been illustrated specifically in relation to a tyre, other crosslinked elastomeric manufactured products that can be produced according to the invention may be, for example, conveyor belts, driving belts or flexible tubes.

The present invention will be further illustrated below by means of a number of preparation examples, which are given for purely indicative purposes and without any limitation of this invention.

### EXAMPLE 1

### Preparation of the Elastomeric Compositions

The elastomeric compositions given in Table 1 were prepared as follows (the amounts of the various components are given in phr unless otherwise indicated).

All the ingredients, except for the sulphur and the accelerator (CBS), were mixed together in an internal mixer (model Pomini PL 1.6) for about 5 min (1st Stage). As soon as the temperature reached 145±5° C., the elastomeric composition was discharged. The sulphur and the accelerator were then added and mixing was carried out in an open roll mixer (2nd Stage).

TABLE 2

| | | |
|---|---|---|
| EXAMPLE 1 | 1 (*) | 2 |

1^{st} STAGE

| | | |
|---|---|---|
| NR | 50 | 50 |
| BR | 50 | 50 |
| Carbon black | 60 | 60 |
| Zinc oxide | 3 | 3 |
| Stearic acid | 2 | 2 |
| Aromatic oil | 15 | 15 |
| Antioxidant | 4 | 4 |
| Paraffin wax | 2 | 2 |
| Polymer (c) | — | 2 (**) |

2^{nd} STAGE

| | | |
|---|---|---|
| CBS | 1 | 1 |
| Sulphur | 2 | 2 |

(*): comparative.
(**): the amount is expressed in % by weight, with respect to the weight of the paraffin wax.

NR: natural rubber;
BR: cis-1,4-polybutadiene (Europrene® Neocis BR40—EniChem Elastomeri);
Carbon black: N330 (Vulcan® 3—Cabot);
Antioxidant: phenyl-p-phenylenediamine;
Paraffin wax: SER® A054 from Ser having a content of linear saturated hydrocarbon of 76% by weight; a content of linear saturated hydrocarbons having from 20 to 29 of 23% by weight; a content of linear saturated hydrocarbons having from 30 to 35 carbon of 41% by weigth; a content of linear saturated hydrocarbons having from 36 to 42 carbon atoms of 35% by weight (the composition of the paraffin wax was determined by means of a capillary gas-chromatograph (Mod. 68090N manufactured by Agilent Technologies) equipped with and a capillary column having a stationary phase made of cross-linked silicone rubber (5% phenyl-methyl-siloxane

manufactured under the tradename ULTRA® 2 by Agilent Technologies);

polymer (c): VYBARO® 103 from Backer Petrolite Corp. having a number average molecular weight of 2800;

CBS (accelerator): N-cyclohexyl-2-benzothiazyl-sulphenamide (Vulkacit® CZ—Bayer).

Each composition was calendered so as to obtain a test specimen having 20 mm width and 2 mm thickness which was subsequently vulcanized at 160° C. for 20 min. The test specimens so obtained were elongated and fixed to various strains operating as follows: the test specimen was putted in a frame having clamps which were applied to the free section of each test specimen; a manual traction was then applied until the test specimem reached the following strains: 20%, 30%, and 50%; the clamps were fixed in order to maintain said strains.

The elongated test specimens so obtained were placed in a test chamber apparatus Mod. 703, made by Hampden, in order to evaluate the degradation by ozone operating at the following conditions:

ozone concentration: 200±30 pphm (parts per hundred millions);

temperature: 23±1° C.;

exposure time: 46 hours.

After 46 hours at the conditions reported above, the test specimens were examined visually in order to determine the presence of cracks: none of the test specimens showed any detectable cracks.

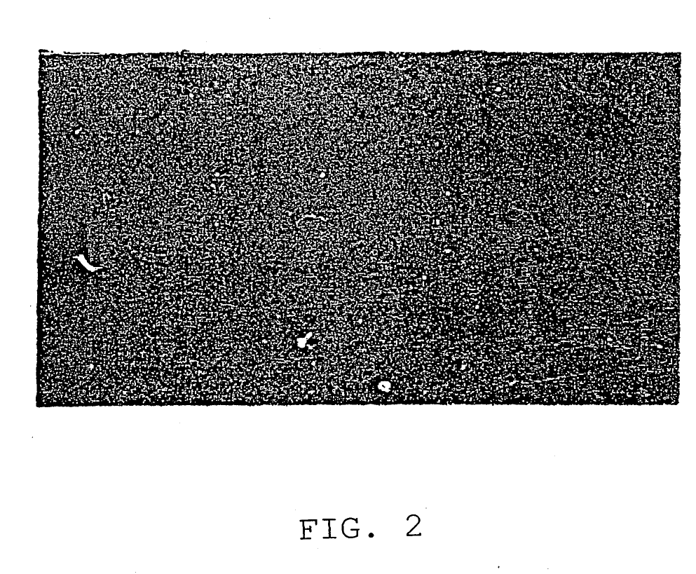

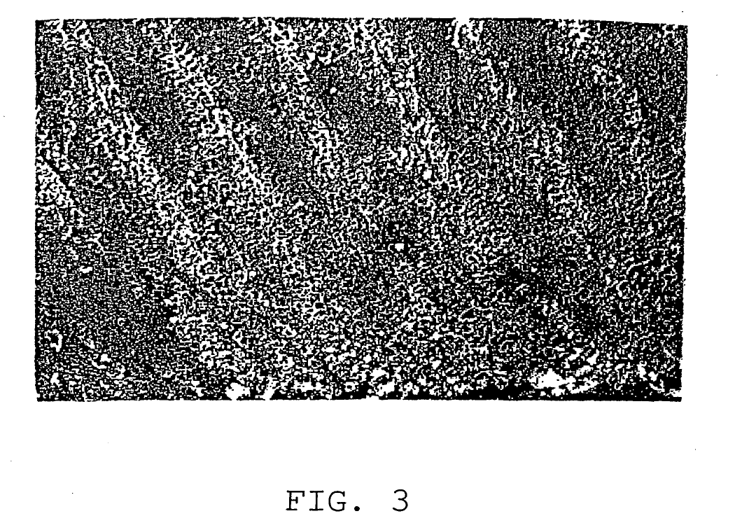

Furthermore, the migration of the wax paraffin on the surfaces of the sheet specimens was checked by subjecting the test specimens, previously gold sputtered, to the scanning electron microscopic photography by means of Jeol JSM-840A scanning electron microsope (SEM). The obtained photographs are reported in FIG. 2 and FIG. 3. The photographs clearly show that the composition according to the present invention (Example 2—FIG. 2) does not appreciably migrate onto the surface of the test specimen.

1-47. (canceled)

48. A tyre for a vehicle wheel, comprising:
at least one structural element made of a crosslinked elastomeric material;
wherein the crosslinked elastomeric material comprises an elastomeric composition, and wherein the elastomeric composition comprises:
(a) at least one diene elastomeric polymer;
(b) at least one paraffin wax; and
(c) at least one polymer of at least one C₃-C₂₄ α-olefin; and
wherein the at least one polymer (c) has a number average molecular weight not higher than 10,000.

49. The tyre of claim 48, comprising:
a carcass structure;
a belt structure applied in a circumferentially external position relative to the carcass structure;
a tread band superimposed circumferentially on the belt structure; and
a pair of sidewalls applied laterally on opposite sides relative to the carcass structure;
wherein the carcass structure comprises at least one carcass ply shaped in a toroidal configuration,
wherein opposite lateral edges of the at least one carcass ply are associated with respective bead wires,
wherein each bead wire is enclosed in a respective bead,
wherein the belt structure comprises at least one belt strip, and
wherein the pair of sidewalls is formed by the elastomeric composition.

50. The tyre of claim 48, wherein the at least one polymer (c) is a polymer of at least one C₅-C₁₈ α-olefin.

51. The tyre of claim 48, wherein the at least one polymer (c) has a number average molecular weight not higher than about 5,000.

52. The tyre of claim 48, wherein the at least one polymer (c) has a number average molecular weight not higher than about 3,000.

53. The tyre of claim 48, wherein the at least one polymer (c) has a number average molecular weight of at least about 300.

54. The tyre of claim 48, wherein the at least one polymer (c) has a number average molecular weight of at least about 400.

55. The tyre of claim 48, wherein the at least one polymer (c) has a number average molecular weight of at least about 500.

56. The tyre of claim 48, wherein the at least one polymer (c) has a polydispersity value of at least about 2.

57. The tyre of claim 48, wherein the at least one polymer (c) has a polydispersity value not higher than about 20.

58. The tyre of claim 48, wherein the at least one polymer (c) has a polydispersity value not higher than about 12.

59. The tyre of claim 48, wherein the at least one polymer (c) has a melting point or a softening point of at least about 30° C.

60. The tyre of claim 48, wherein the at least one polymer (c) has a melting point or a softening point not higher than about 120° C.

61. The tyre of claim 48, wherein the at least one polymer (c) has the following degree of branching: from 1 mol % to 20 mol % of methyl groups with respect to a total number of carbon atoms.

62. The tyre of claim 48, wherein the at least one polymer (c) has the following degree of branching: from 2 mol % to 10 mol % of methyl groups with respect to a total number of carbon atoms.

63. The tyre of claim 48, wherein the at least one polymer (c) has the following degree of branching: from 80 mol % to 99 mol % of methylene groups (secondary carbon atoms) with respect to a total number of carbon atoms.

64. The tyre of claim 48, wherein the at least one polymer (c) has the following degree of branching: from 90 mol % to 95 mol % of methylene groups (secondary carbon atoms) with respect to a total number of carbon atoms.

65. The tyre of claim 48, wherein the at least one polymer (c) has the following degree of branching: from 1 mol % to 20 mol % of tertiary carbon atoms with respect to a total number of carbon atoms.

66. The tyre of claim 48, wherein the at least one polymer (c) has the following degree of branching: from 2 mol % to 10 mol % of tertiary carbon atoms with respect to a total number of carbon atoms.

67. The tyre of claim 48, wherein the at least one polymer (c) has the following degree of branching: from 0 mol % to 2 mol % of quaternary carbon atoms with respect to a total number of carbon atoms.

68. The tyre of claim 48, wherein the at least one polymer (c) has the following degree of branching: from 0 mol % to 1 mol % of quaternary carbon atoms with respect to a total number of carbon atoms.

69. The tyre of claim 48, wherein the at least one polymer (c) has a crystallinity degree of from 30% to 99%.

70. The tyre of claim 48, wherein the at least one polymer (c) has a crystallinity degree of from 50% to 90%.

71. The tyre of claim 48, wherein the at least one polymer (c) is saturated or unsaturated and comprise cyclic moieties.

72. The tyre of claim 48, wherein the at least one polymer (c) comprises cyclic moieties.

73. The tyre of claim 48, wherein the at least one polymer (c) is present in the elastomeric composition in an amount of from 0.1 %-by-weight to 10%-by-weight with respect to a weight of the at least one paraffin wax (b).

74. The tyre of claim 48, wherein the at least one polymer (c) is present in the elastomeric composition in an amount of from 0.5%-by-weight to 5%-by-weight with respect to a weight of the at least one paraffin wax (b).

75. The tyre of claim 48, wherein the at least one paraffin wax (b) comprises linear saturated hydrocarbons, branched saturated hydrocarbons, or linear and branched saturated hydrocarbons.

76. The tyre of claim 48, wherein the at least one paraffin wax (b) comprises a mixture of linear and branched saturated hydrocarbons, and wherein a content of linear saturated hydrocarbon is at least 40%-by-weight.

77. The tyre of claim 48, wherein the at least one paraffin wax (b) comprises a mixture of linear and branched saturated hydrocarbons, and wherein a content of linear saturated hydrocarbon is of from 55%-by-weight to 80%-by-weight.

78. The tyre of claim 75, wherein the linear saturated hydrocarbons comprise:
at least from 20 to 29 carbon atoms in an amount of from 10%-by-weight to 40%-by-weight;
at least from 30 to 35 carbon atoms in an amount of from 20%-by-weight to 65%-by-weight; and
at least from 36 to 42 carbon atoms in an amount of from 10%-by-weight to 50%-by-weight.

79. The tyre of claim 48, wherein the at least one paraffin wax (b) is present in the elastomeric composition in an amount of from 0.5 phr to 10 phr.

80. The tyre of claim 48, wherein the at least one paraffin wax (b) is present in the elastomeric composition in an amount of from 1.5 phr to 4 phr.

81. The tyre of claim 48, wherein the at least one diene elastomeric polymer (a) has a glass transition temperature (T_{g}) below 20° C.

82. The tyre of claim 81, wherein the at least one diene elastomeric polymer (a) comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

83. The tyre of claim 48, wherein the elastomeric composition comprises at least one elastomeric polymer of one or more monoolefins with an olefinic comonomer or derivatives thereof (a′).

84. The tyre of claim 83, wherein the at least one elastomeric polymer (a′) comprises one or more of: ethylene/propylene copolymers (EPR) or ethylene/propylene/diene copolymers (EPDM); polyisobutene; butyl rubbers; and halobutyl rubbers.

85. The tyre of claim 48, wherein at least one reinforcing filler is present in the elastomeric composition in an amount of between 0.1 phr and 120 phr.

86. The tyre of claim 85, wherein the at least one reinforcing filler comprises carbon black.

87. The tyre of claim 85, wherein the at least one reinforcing filler comprises silica.

88. An elastomeric composition, comprising:
(a) at least one diene elastomeric polymer;
(b) at least one paraffin wax; and
(c) at least one polymer of at least one C₃-C₂₄ α-olefin;
wherein the at least one polymer (c) has a number average molecular weight not higher than 10,000.

89. The elastomeric composition of claim 88, wherein the at least one diene elastomeric polymer (a) has a glass transition temperature (T_{g}) below 20° C.

90. The elastomeric composition of claim 88, wherein the at least one paraffin wax (b) comprises linear saturated hydrocarbons, branched saturated hydrocarbons, or linear and branched saturated hydrocarbons.

91. The elastomeric composition of claim 88, wherein the at least one polymer (c) is a polymer of at least one C₅-C₁₈ α-olefin.

92. The elastomeric composition of claim 88, wherein at least one reinforcing filler is present in an amount of between 0.1 phr and 120 phr.

93. The elastomeric composition of claim 92, wherein the at least one reinforcing filler comprises carbon black, silica, or carbon black and silica.

94. A crosslinked elastomeric manufactured product obtained by crosslinking an elastomeric composition, wherein the elastomeric composition comprises:
(a) at least one diene elastomeric polymer;
(b) at least one paraffin wax; and
(c) at least one polymer of at least one C₃-C₂₄ α-olefin; and
wherein the at least one polymer (c) has a number average molecular weight not higher than 10,000.
